(19) United States
(12) Patent Application Publication
(10) Pub. No.: US 2015/0098706 A1
(43) Pub. Date: Apr. 9, 2015

(54) LIGHT SEQUENCE OUT-OF-BAND BLUETOOTH PAIRING

(71) Applicant: Tyfone, Inc., Portland, OR (US)

(72) Inventors: Siva G. Narendra, Portland, OR (US); Saurav Chakraborty, West Bengal (IN); Donald Allen Bloodworth, Camas, WA (US); Prabhakar Tadepalli, Bangalore (IN); Pradeep H. Rajashekarappa, Bangalore (IN)

(21) Appl. No.: 14/047,023

(22) Filed: Oct. 7, 2013

(51) Int. Cl. H04B 10/114

(52) U.S. Cl. CPC H04B 10/1143
USPC 398/115

(57) ABSTRACT

An out-of-band (OOB) mechanism is used to communicate a Bluetooth pairing code from a token to a mobile device. The token may include a light source and the mobile device may include a camera to communicate the Bluetooth pairing code using a light sequence. The token may include a speaker and the mobile device may include a microphone to communicate the Bluetooth pairing code.

### FIELD

The present invention relates generally to mobile devices, and more specifically to pairing mobile devices using radio technologies.

### BACKGROUND

Bluetooth technology is generally well known. Bluetooth compatible devices communicate over short distances using the Industrial, Scientific, and Medical (ISM) 2.4 GHz frequency band. Bluetooth compatible devices are “paired” prior to communicating. Pairing of Bluetooth compatible devices is typically accomplished by entering a shared PIN code on the devices to be paired.

### BRIEF DESCRIPTION OF THE DRAWINGS

FIG. 1 shows a token providing a Bluetooth pairing code to a mobile device using an out-of-band (OOB) mechanism;

FIG. 2 shows a token providing a Bluetooth pairing code to a mobile device using a light sequence;

FIG. 3 shows a token providing a Bluetooth pairing code to a mobile device using an audio sequence;

FIG. 4 shows a token providing a Bluetooth pairing code to a mobile device using a light sequence;

FIG. 5 shows a token providing a Bluetooth pairing code to a mobile device using an audio sequence;

FIG. 6 shows a block diagram of a token in accordance with various embodiments of the present invention;

FIG. 7 shows a flowchart of methods in accordance with various embodiments of the present invention;

FIG. 8 shows a sequence that represents a Bluetooth pairing code;

FIG. 9 shows a block diagram of a mobile device in accordance with various embodiments of the present invention; and

FIG. 10 shows a flowchart of methods in accordance with various embodiments of the present invention.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

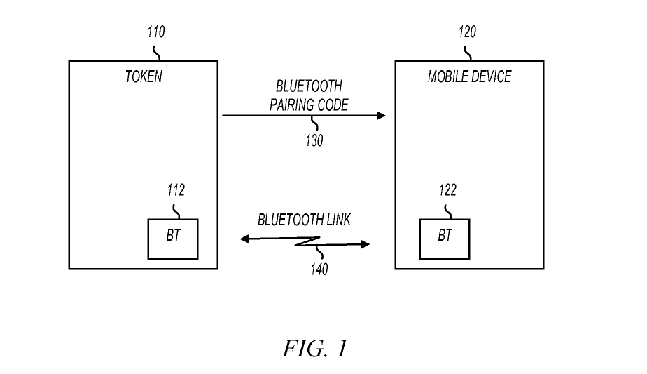

FIG. 1 shows a token providing a Bluetooth pairing code to a mobile device using an out-of-band (OOB) mechanism. Token 110 includes Bluetooth (BT) device 112, and mobile device 120 includes Bluetooth device 122. Bluetooth devices 112 and 122 are shown communicating over Bluetooth link 140. Devices 110 and 120 are said to be “paired” because their respective Bluetooth devices are communicating over link 140. Bluetooth devices 112 and 122 are also said to be “paired.”

In various embodiments of the present invention, token 110 communicates a Bluetooth pairing code to mobile device 120 using an out-of-band (OOB) mechanism as shown at 130. For example, in some embodiments, token 110 may include a light source that blinks a light sequence that represents a Bluetooth pairing code. In these embodiments, mobile device 120 includes a camera that receives the light sequence. Also for example, in some embodiments, token 110 may include a speaker that emits an audio sequence that represents a Bluetooth pairing code. In these embodiments, mobile device 120 includes a microphone that receives the audio sequence.

In operation, token 110 provides the Bluetooth pairing code to mobile device 120 using the OOB mechanism, and then mobile device 120 provides the pairing code to Bluetooth device 122 to allow Bluetooth device 122 to pair with Bluetooth device 112. As used herein, the term “out-of-band” refers to any communications mechanism other than a Bluetooth radio.

In some embodiments, an application may run on mobile device 120 that prompts a user to interact with token 110 to cause token 110 to emit the sequence representing the Bluetooth pairing code. For example, mobile device 120 may prompt a user to point a camera included within mobile device 120 at token 110, and then press a button on token 110 to cause token 110 to blink a light sequence that represents the Bluetooth pairing code. Also for example, mobile device 120 may prompt a user to hold mobile device 120 near token 110 so that a microphone within mobile device 120 can receive an audio sequence. The user may also be prompted to interact with token 110 to cause the token to emit the audio sequence that represents the Bluetooth pairing code.

Mobile device 120 may be any electronic device capable of performing as described herein. For example, mobile device 120 may be a smartphone, tablet, personal computer, laptop, phablet, mobile phone, or the like.

Token 110 also may be any electronic device capable of performing as described herein. For example, token 110 may be a bracelet, a card, a key fob, a keychain token, or the like.

FIG. 2 shows a token providing a Bluetooth pairing code to a mobile device using a light sequence. Token 210 is a token (such as token 110, FIG. 1) that communicates a Bluetooth pairing code using an OOB mechanism, where the OOB mechanism includes the transmission of light. In embodiments represented by FIG. 2, token 210 is in the form of a key fob. Token 210 includes at least one light source 212. The light source may be a light emitting diode (LED), or any other type of light source. In operation, light source 212 blinks a light sequence that represents a Bluetooth pairing code.

In some embodiments, light source 212 emits visible light, and in other embodiments, light source 212 emits nonvisible light, such as light in the infrared spectrum. In still further embodiments, light source 212 emits light in both the visible and nonvisible spectrums. For example, one LED may emit visible light to alert a user that it is operating, while another LED emits nonvisible light to blink the sequence that includes the Bluetooth pairing code.

Mobile device 230 is a mobile device (such as mobile device 120, FIG. 1) that receives a Bluetooth pairing code using an OOB mechanism, where the OOB mechanism includes the reception of light. In embodiments represented by FIG. 2, mobile device 230 is in the form of a mobile phone. Mobile device 230 includes a camera (not shown) to receive the light sequence emitted by token 212. In operation, mobile device 230 receives the light sequence and interprets the light sequence to determine the Bluetooth pairing code. The Bluetooth pairing code is then used to pair mobile device 230 and token 210.

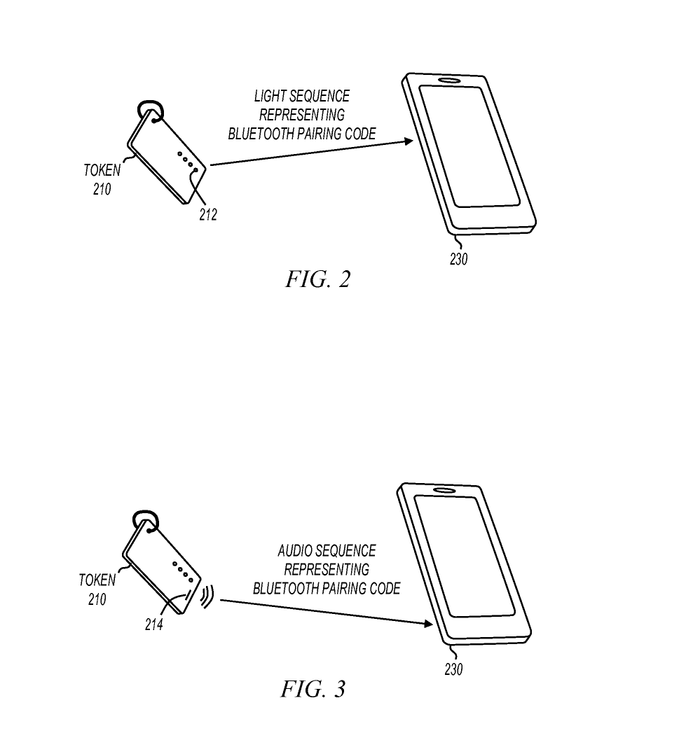

FIG. 3 shows a token providing a Bluetooth pairing code to a mobile device using an audio sequence. Token 210 is a token (such as token 110, FIG. 1) that communicates a Bluetooth pairing code using an OOB mechanism, where the OOB mechanism includes the transmission of audio waves. In embodiments represented by FIG. 3, token 210 is in the form of a key fob. Token 210 includes at least one speaker 214. The speaker may emit an audible audio sequence or an inaudible audio sequence. In operation, speaker 214 emits an audio sequence that represents a Bluetooth pairing code.

Mobile device 230 is a mobile device (such as mobile device 120, FIG. 1) that receives a Bluetooth pairing code using an OOB mechanism, where the OOB mechanism includes the reception of audio waves. In embodiments represented by FIG. 3, mobile device 230 is in the form of a mobile phone. Mobile device 230 includes a microphone (not shown) to receive the audio sequence emitted by token 212. In operation, mobile device 230 receives the audio sequence and interprets the audio sequence to determine the Bluetooth pairing code. The Bluetooth pairing code is then used to pair mobile device 230 and token 210.

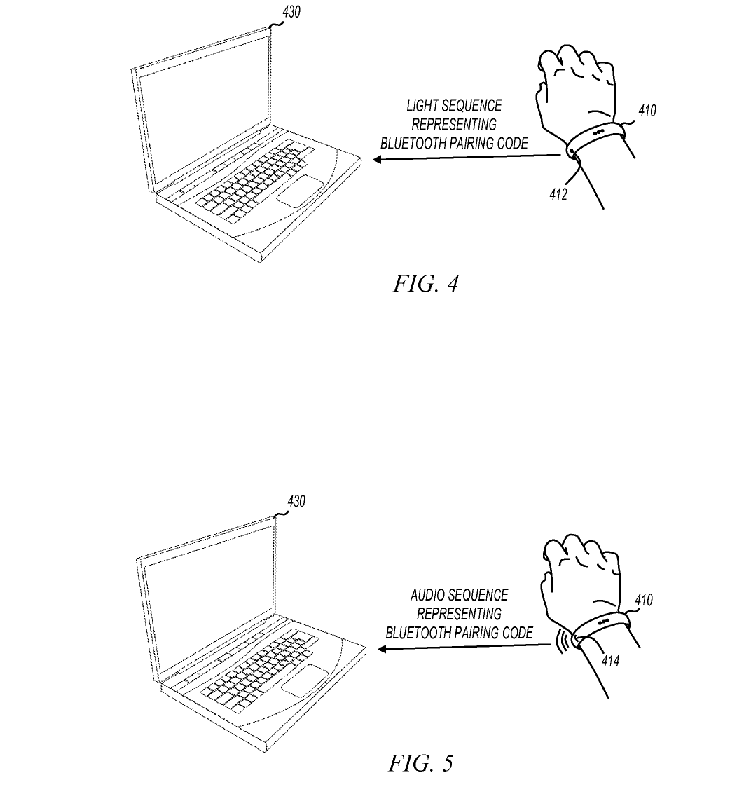

FIG. 4 shows a token providing a Bluetooth pairing code to a mobile device using a light sequence. Token 410 is a token (such as token 110, FIG. 1) that communicates a Bluetooth pairing code using an OOB mechanism, where the OOB mechanism includes the transmission of light. In some embodiments, token 410 is a wearable device. In embodiments represented by FIG. 4, token 410 is in the form of a bracelet. Token 410 may be any type of wearable device without departing from the scope of the present invention. Token 410 includes at least one light source 412. The light source may be a light emitting diode (LED), or any other type of light source. In operation, light source 412 blinks a light sequence that represents a Bluetooth pairing code.

In some embodiments, light source 412 emits visible light, and in other embodiments, light source 412 emits nonvisible light, such as light in the infrared spectrum. In still further embodiments, light source 412 emits light in both the visible and nonvisible spectrums. For example, one LED may emit visible light to alert a user that it is operating, while another LED emits nonvisible light to blink the sequence that includes the Bluetooth pairing code.

Mobile device 430 is a mobile device (such as mobile device 120, FIG. 1) that receives a Bluetooth pairing code using an OOB mechanism, where the OOB mechanism includes the reception of light. In embodiments represented by FIG. 4, mobile device 230 is in the form of a laptop computer. Mobile device 430 includes a camera (not shown) to receive the light sequence emitted by token 412. In operation, mobile device 430 receives the light sequence and interprets the light sequence to determine the Bluetooth pairing code. The Bluetooth pairing code is then used to pair mobile device 430 and token 410.

FIG. 5 shows a token providing a Bluetooth pairing code to a mobile device using an audio sequence. Token 410 is a token (such as token 110, FIG. 1) that communicates a Bluetooth pairing code using an OOB mechanism, where the OOB mechanism includes the transmission of audio waves. In embodiments represented by FIG. 5, token 410 is in the form of a bracelet. Token 410 includes at least one speaker 414. The speaker may emit an audible audio sequence or an inaudible audio sequence. In operation, speaker 414 emits an audio sequence that represents a Bluetooth pairing code.

Mobile device 430 is a mobile device (such as mobile device 120, FIG. 1) that receives a Bluetooth pairing code using an OOB mechanism, where the OOB mechanism includes the reception of audio waves. In embodiments represented by FIG. 5, mobile device 430 is in the form of a laptop computer. Mobile device 430 includes a microphone (not shown) to receive the audio sequence emitted by token 412. In operation, mobile device 430 receives the audio sequence and interprets the audio sequence to determine the Bluetooth pairing code. The Bluetooth pairing code is then used to pair mobile device 430 and token 410.

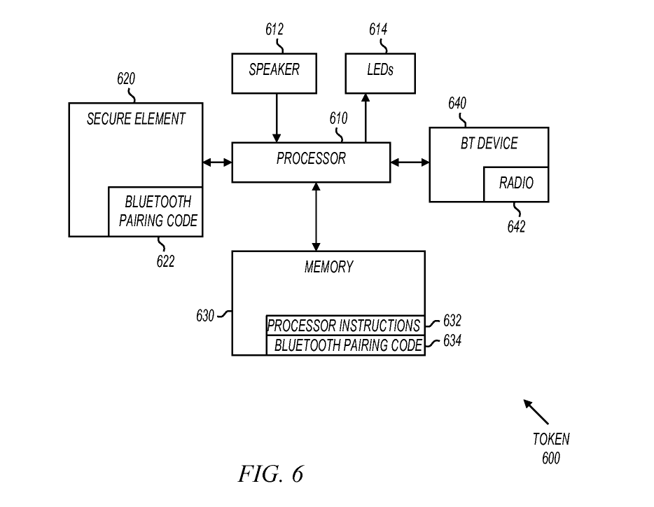

FIG. 6 shows a block diagram of a token in accordance with various embodiments of the present invention. Token 600 is an example architecture capable of performing as described herein. For example, token 110, token 210, or token 410 may include the functional blocks shown in FIG. 6. Token 600 includes processor 610, memory 630, Bluetooth device 640, secure element 620, speaker 612, and light emitting diodes (LEDs) 614.

Light emitting diodes 614 are an example of a light source, such as light source 212 (FIGS. 2, 3) and light source 412 (FIGS. 4, 5). Token 600 may include any type of light source; the light source type is not restricted to LEDs. LEDs 614 may emit light of any wavelength. For example, LEDs 614 may emit light in the visible spectrum, in the nonvisible spectrum, or any combination. Speaker 612 is coupled to processor 610, and in some embodiments, emits an audio sequence that represents a Bluetooth pairing code.

Bluetooth device 640 includes radio 642, and is coupled to processor 610. In operation, Bluetooth device 640 communicates with a Bluetooth device in a separate device. For example, when paired, Bluetooth device 640 may communicate with a Bluetooth device in a mobile device, such as any of mobile devices 110 (FIG. 1), 210 (FIG. 2, 3), or 410 (FIGS. 4, 5).

Processor 610 may be any type of processor capable of executing instructions stored in memory 630 and capable of interfacing with the various components shown in FIG. 6. For example, processor 610 may be a microprocessor, a digital signal processor, an application specific processor, or the like. In some embodiments, processor 630 is a component within a larger integrated circuit such as a system on chip (SOC) application specific integrated circuit (ASIC).

Memory 630 may include any type of memory device. For example, memory 630 may include volatile memory such as static random access memory (SRAM), or nonvolatile memory such as FLASH memory. Memory 630 is encoded with (or has stored therein) one or more software modules (or sets of instructions), that when accessed by processor 610, result in processor 610 performing various functions. For example, memory 630 is shown encoded with processor instructions 632.

Memory 630 may also store a Bluetooth pairing code 634. In operation, when executing processor instructions 632, processor 610 may retrieve Bluetooth pairing code 634 from memory 630, and cause Bluetooth pairing code 634 to be transmitted using an OOB mechanism. For example, one or more of LEDs 614 may blink a light sequence that represents Bluetooth pairing code 634, and/or speaker 612 may emit an audio sequence that represents Bluetooth pairing code 634. Bluetooth pairing code 634 is a pairing code that will allow BT device 640 to pair with another BT device in a separate apparatus. For example, after Bluetooth pairing code 634 is transmitted to a separate device, that separate device may use Bluetooth pairing code 634 to pair with BT device 640.

Bluetooth pairing code 634 may originate from BT device 640, processor 610, secure element 620, or any other location. For example, in some embodiments, BT device 640 is pre-provisioned to use Bluetooth pairing code 634. In these embodiments, processor 610 may read Bluetooth pairing code 634 from BT device 640 and store it in memory 630. Also in some embodiments, processor 610 may generate Bluetooth pairing code 634, store it in memory device 630, and communicate it to BT device 640. In still further embodiments, a user may enter Bluetooth pairing code 634 using an interface (not shown) on token 600.

Secure element 620 provides secure information storage. Secure element 620 may store or generate a Bluetooth pairing code as shown at 622. In some embodiments, secure element 620 generates Bluetooth pairing code 622 using a random number generator. In other embodiments, secure element 620 securely stores a static Bluetooth pairing code.

Examples of secure elements are the “SmartMX” controllers sold by NXP Semiconductors N.V. of Eindhoven, The Netherlands. In some embodiments, secure element 620 has an ISO/IEC 7816 compatible interface that communicates with other components within token 600 (e.g., processor 610), although this is not a limitation of the present invention. Further, in some embodiments, secure element 620 includes a near field communications (NFC) radio (not shown) that includes an ISO/IEC 14443 contactless interface.

In operation, processor 610 retrieves a Bluetooth pairing code from one or both of memory device 630 and secure element 620. Processor 610 provides the Bluetooth pairing code to Bluetooth device 640, and also provides the same Bluetooth pairing code to a mobile device using an OOB mechanism, such as speaker 612 and/or light source 614. When the mobile device receives and uses the Bluetooth pairing code, token 600 may be paired with the mobile device.

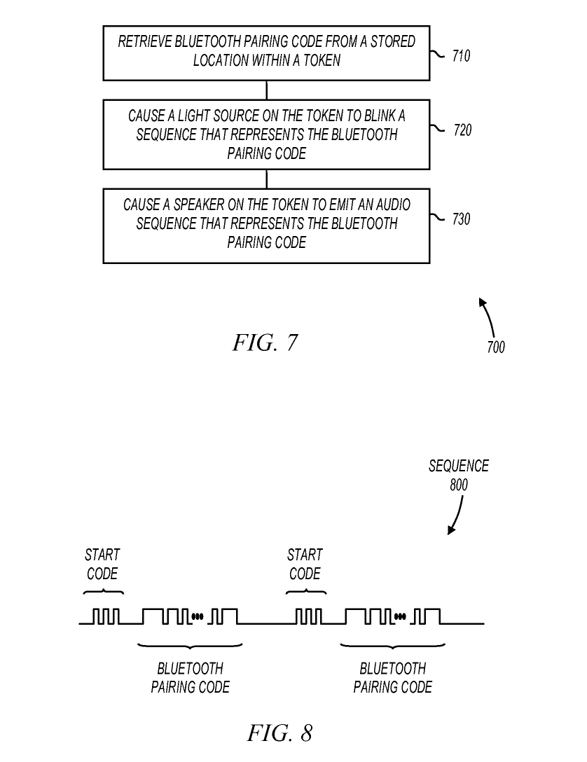

FIG. 7 shows a flowchart of methods in accordance with various embodiments of the present invention. In some embodiments, method 700 may be performed by a token such any of those shown in previous figures. Further, in some embodiments, method 700 may be performed by a processor such as processor 610 (FIG. 6). Method 700 is not limited by the type of system or entity that performs the method. The various actions in method 700 may be performed in the order presented, in a different order, or simultaneously. Further, in some embodiments, some actions listed in FIG. 7 are omitted from method 700.

Method 700 begins at 710 in which a Bluetooth pairing code is retrieved from a stored location within a token. In some embodiments, this corresponds to a token retrieving a code from a memory device, such as code 634 (FIG. 6). In other embodiments, this corresponds to a token retrieving a code from a secure element, such as code 622.

At 720, a light source blinks a sequence that represents the Bluetooth pairing code. In some embodiments, this corresponds to a token such as token 110 (FIG. 1), 210 (FIGS. 2, 3), 410 (FIG. 4, 5), or 600 (FIG. 6) blinking a light sequence from a light emitting diode. The light may be visible, nonvisible, or any combination.

At 730, a speaker emits an audio sequence that represents the Bluetooth pairing code. In some embodiments, this corresponds to a token such as token 110 (FIG. 1), 210 (FIGS. 2, 3), 410 (FIG. 4, 5), or 600 (FIG. 6) emitting an audio sequence from a speaker.

FIG. 8 shows a sequence that represents a Bluetooth pairing code. Sequence 800 includes a start code and a Bluetooth pairing code. In some embodiments, the sequence repeats. For example, sequence 800 shows repeating the start code and Bluetooth pairing code once. In some embodiments, the sequence is repeated many times. The sequence may be repeated for as long as a user is interacting with a token. For example, a token may include a button, and the sequence may be emitted for as long as the button is pressed.

Sequence 800 is transmitted from a token using an OOB mechanism such as light and/or audio. For example, speaker 612 (FIG. 6) may emit an audio wave that represents sequence 800. Also for example, LEDs 614 (FIG. 6) may blink a light sequence that represents sequence 800.

Sequence 800 is received by a mobile device using an OOB mechanism such as light and/or audio. For example, a mobile device may include a microphone to receive an audio wave that represents sequence 800. Also for example, a mobile device may include a camera to receive light that represents sequence 800. When the mobile device receives sequence 800, the mobile device may interpret the Bluetooth pairing code, and cause the mobile device to pair with the token that transmitted sequence 800.

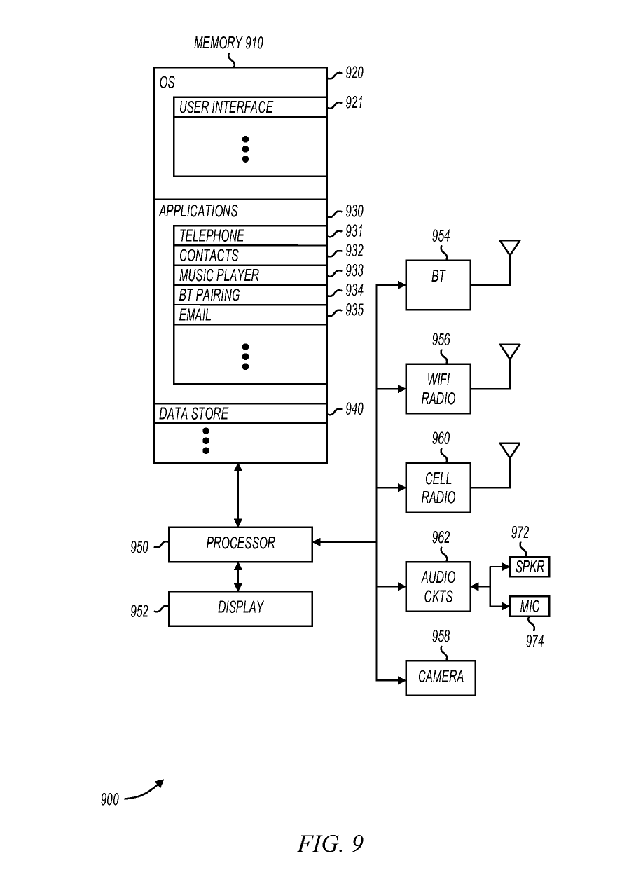

FIG. 9 shows a block diagram of a mobile device in accordance with various embodiments of the present invention. Mobile device 900 includes processor 950, memory 910, display device 952, cellular radio 960, audio circuits 962, Bluetooth device 954, Wi-Fi radio 956, and camera 958. Mobile device 900 represents any type of mobile device capable of performing as described herein, including any of mobile devices 120, 230, and 430 (FIGS. 1-5). For example, in some embodiments, mobile device 900 may be a cell phone, a smartphone, a tablet computer, a laptop computer, or the like.

Processor 950 may be any type of processor capable of executing instructions stored in memory 910 and capable of interfacing with the various components shown in FIG. 9. For example, processor 950 may be a microprocessor, a digital signal processor, an application specific processor, or the like. In some embodiments, processor 950 is a component within a larger integrated circuit such as a system on chip (SOC) application specific integrated circuit (ASIC).

Display device 952 is an output device capable of presenting information for visual, audible, or tactile reception. Examples include, but are not limited to, analog electronic displays, digital displays, monitor displays, and the like. Further, in some embodiments, display device 952 may include a touch sensitive surface, sensor, or set of sensors that accept input from a user. For example, display device 952 may detect when and where an object touches the screen, and may also detect movement of an object across the screen. When touch sensitive display device detects input, processor 950 (in association with user interface component 921) may determine whether a gesture is to be recognized.

Display device 952 may be manufactured using any applicable display technologies, including for example, liquid crystal display (LCD), active matrix organic light emitting diode (AMOLED), and the like. Further, display device 952 may be manufactured using any application touch sensitive input technologies, including for example, capacitive and resistive touch screen technologies, as well as other proximity sensor technologies.

Cellular radio 960 may be any type of radio that can communicate within a cellular network. Examples include, but are not limited to, radios that communicate using orthogonal frequency division multiplexing (OFDM), code division multiple access (CDMA), time division multiple access (TDMA), and the like. Cellular radio 960 may operate at any frequency or combination of frequencies without departing from the scope of the present invention. In some embodiments, cellular radio 960 is omitted.

Bluetooth radio 954 is a type of non-near field radio capable of communicating on a frequency between 2.402 GHz and 2.480 GHz. Bluetooth is an example of a non-near-field protocol because the wavelength is on the order of 4.5 inches and the intended communication distance is typically much greater than 4.5 inches. The use of the term “non-near-field radio” is not meant to imply that the distance of communication cannot be less than the wavelength for the non-near-field radio. Bluetooth radio 954 is capable of communicating on a personal-area network (PAN) with other Bluetooth devices on the personal-area network.

Wi-Fi radio 956 is a wireless device capable of connecting to a wireless access point and allows for the connectivity on to a wireless network using IEEE 802.11 networking standards. In some embodiments Wi-Fi radio 956 is omitted.

Audio circuits 962 provide an interface between processor 950 and audio devices such as speaker 972 and microphone 974.

Mobile device 900 may also include many other circuits and services that are not specifically shown in FIG. 9. For example, in some embodiments, mobile device 900 may include a global positioning system (GPS) radio, haptic feedback devices, and the like. Any number and/or type of circuits and services may be included within mobile device 900 without departing from the scope of the present invention.

Memory 910 may include any type of memory device. For example, memory 910 may include volatile memory such as static random access memory (SRAM), or nonvolatile memory such as FLASH memory. Memory 910 is encoded with (or has stored therein) one or more software modules (or sets of instructions), that when accessed by processor 950, result in processor 950 performing various functions. In some embodiments, the software modules stored in memory 910 may include an operating system (OS) 920 and applications 930. Applications 930 may include any number or type of applications. Examples provided in FIG. 9 include a telephone application 931, a contacts application 932, a music player application 933, a Bluetooth pairing application 934, and an email application 935. Memory 910 may also include any amount of space dedicated to data storage 940.

Operating system 920 may be a mobile device operating system such as an operating system to control a mobile phone, smartphone, tablet computer, laptop computer, or the like. As shown in FIG. 9, operating system 920 includes a user interface component 921. Operating system 920 may include many other components without departing from the scope of the present invention.

User interface component 921 includes processor instructions that cause mobile device 900 to display desktop screens, recognize gestures, and provide navigation between desktop screens. User interface 921 also includes instructions to display menus, move icons, and manage other portions of the display environment.

Telephone application 931 may be an application that controls a cell phone radio. Contacts application 932 includes software that organizes contact information. Contacts application 932 may communicate with telephone application 931 to facilitate phone calls to contacts. Music player application 933 may be a software application that plays music files that are stored in data store 940. Email application 935 may be a software application that allows a user to send and receive email.

Each of the above-identified applications corresponds to a set of instructions for performing one or more functions described above. These applications (sets of instructions) need not be implemented as separate software programs, procedures or modules, and thus various subsets of these applications may be combined or otherwise re-arranged in various embodiments. For example, telephone application 931 may be combined with contacts application 932. Furthermore, memory 910 may store additional applications (e.g., video players, camera applications, etc.) and data structures not described above.

It should be noted that device 900 is presented as an example of a mobile device, and that device 900 may have more or fewer components than shown, may combine two or more components, or may have a different configuration or arrangement of components. For example, mobile device 900 may include many more components such as sensors (optical, touch, proximity etc.), or any other components suitable for use in a mobile device.

In some embodiments, Bluetooth pairing application 934 causes processor 950 to receive and interpret a Bluetooth pairing code received using an OOB mechanism. For example, a light sequence such as sequence 800 (FIG. 8) may be received by camera 958, and the Bluetooth pairing code may be extracted therefrom. The Bluetooth pairing code may then be provided to BT device 954 so that mobile device 900 may be paired with the token that sent the sequence. Also for example, an audio sequence such as sequence 800 (FIG. 8) may be received by microphone 974, and the Bluetooth pairing code may be extracted therefrom. The Bluetooth pairing code may then be provided to BT device 954 so that mobile device 900 may be paired with the token that sent the sequence.

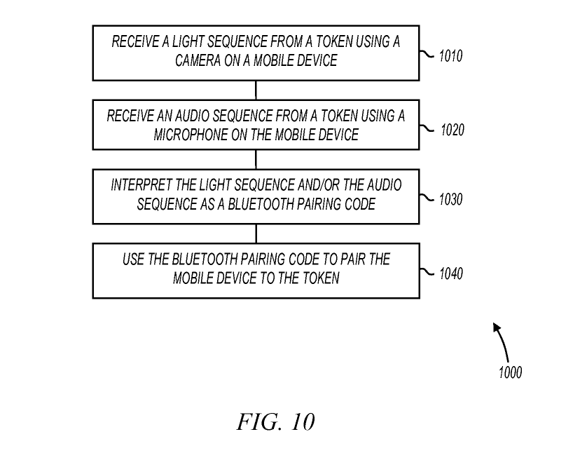

FIG. 10 shows a flowchart of methods in accordance with various embodiments of the present invention. In some embodiments, method 1000 may be performed by a mobile device such any of those shown in previous figures. Further, in some embodiments, method 1000 may be performed by a processor such as processor 950 (FIG. 9). Method 1000 is not limited by the type of system or entity that performs the method. The various actions in method 1000 may be performed in the order presented, in a different order, or simultaneously. Further, in some embodiments, some actions listed in FIG. 10 are omitted from method 1000.

Method 1000 begins at 1010 in which a light sequence is received from a token using a camera on a mobile device. In some embodiments, this corresponds to mobile device 900 (FIG. 9) receiving a sequence such as sequence 800 (FIG. 8) using camera 958. At 1020, an audio sequence is received from a token using a microphone on a mobile device. In some embodiments, this corresponds to mobile device 900 (FIG. 9) receiving a sequence such as sequence 800 (FIG. 8) using microphone 974. In some embodiments, only a light sequence is received, and in other embodiments, only an audio sequence is received.

At 1030, the light sequence and/or audio sequence is interpreted as a Bluetooth pairing code. For example, when the sequence includes a start code and a Bluetooth pairing code as shown in FIG. 8, the start code is found and discarded, and the Bluetooth pairing code is extracted.

At 1040, the Bluetooth pairing code is used to pair the mobile device to the token. In some embodiments, this corresponds to processor 950 (FIG. 9) providing the Bluetooth pairing code to Bluetooth device 954, and Bluetooth device pairing with a Bluetooth device in a token that sent the Bluetooth pairing code using a light sequence and/or an audio sequence.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. An apparatus comprising:
a Bluetooth radio to pair the apparatus with a separate device;
a processor coupled to the Bluetooth radio;
at least one light source coupled to the processor; and
a memory device coupled to the processor, the memory device including instructions that when executed by the processor cause the at least one light source to blink a sequence that represents a Bluetooth pairing code.

2. The apparatus of claim 1 further comprising a secure element, wherein the Bluetooth pairing code is stored in the secure element.

3. The apparatus of claim 2 wherein the secure element generates the Bluetooth pairing code.

4. The apparatus of claim 1 wherein the sequence includes a start code and the Bluetooth pairing code.

5. The apparatus of claim 4 wherein the sequence is repeated at least once.

6. The apparatus of claim 1 wherein the apparatus is a key fob.

7. The apparatus of claim 1 wherein the apparatus is wearable.

8. The apparatus of claim 7 wherein the apparatus is a bracelet.

9. A method of communicating a Bluetooth pairing code comprising:
retrieving the Bluetooth pairing code from a stored location within a token, the token including a Bluetooth device responsive to the Bluetooth pairing code; and
causing a light source on the token to blink a sequence that represents the Bluetooth pairing code.

10. The method of claim 9 further comprising combining the Bluetooth pairing code with a start code to generate the sequence.

11. The method of claim 9 further comprising repeating the sequence at least once.

12. An apparatus comprising:
a Bluetooth radio to pair the apparatus with a separate device;
a processor coupled to the Bluetooth radio;
a camera coupled to the processor; and
a memory device coupled to the processor, the memory device including instructions that when executed by the processor cause the camera to receive a light sequence that represents a Bluetooth pairing code.

13. The apparatus of claim 12 wherein the memory further includes instructions that when executed by the processor cause the Bluetooth pairing code to be used to pair the Bluetooth radio with the separate device.

14. The apparatus of claim 12 wherein the apparatus is a mobile phone.

15. The apparatus of claim 12 wherein the apparatus is a laptop computer.

16. A method of pairing a first Bluetooth device in a mobile device to a second Bluetooth device in a token, the method comprising:
receiving a light sequence using a camera in the mobile device;
interpreting the light sequence as a Bluetooth pairing code; and
using the Bluetooth pairing code to pair the Bluetooth device in the mobile device to the second Bluetooth device in the token.

17. The method of claim 16 wherein receiving a light sequence comprises receiving the light sequence from the token.

18. The method of claim 16 wherein the light sequence includes a start code and the Bluetooth pairing code.

19. The method of claim 16 wherein the mobile device comprises a mobile phone.

20. The method of claim 16 wherein the mobile device comprises a laptop computer.
